(19) United States
(12) Patent Application Publication
(10) Pub. No.: US 2009/0131081 A1
(43) Pub. Date: May 21, 2009

(54) ADJUSTING WLAN SCANNING PARAMETERS BASED ON RATE OF CHANGE OF LOCATION OF MOBILE DEVICE

(75) Inventors: Sherif Abdel-Kader, Waterloo (CA); Neil Adams, Waterloo (CA); Joseph DeCell Gordon, III, Waterloo (CA)

Correspondence Address: INTEGRAL INTELLECTUAL PROPERTY INC., 1370 DON MILLS ROAD, SUITE 300, TORONTO, ON, M3B 3N7, CA

(73) Assignee: RESEARCH IN MOTION LIMITED, Waterloo (CA)

(21) Appl. No.: 11/942,167

(22) Filed: Nov. 19, 2007

(51) Int. Cl. H04Q 7/20

(52) U.S. Cl. 455/456.6; 455/434

(57) ABSTRACT

A mobile device adjusts its scanning parameters, depending on the rate of change of location of the mobile device. Examples of scanning parameters that may be adjusted include a back-off parameter that affects the time between successive scans, and a scan/don't scan parameter that according to its value prevents the mobile device from scanning or permits the mobile device to scan. The mobile device may maintain different back-off parameters for different types of scans. Determining which scanning parameters to adjust and how to adjust them may depend on whether the rate of change of location of the mobile device does not exceed a low threshold, exceeds a high threshold, or exceeds the low threshold and does not exceed the high threshold. Different thresholds may be applied by the mobile device for different types of scans.

### BACKGROUND

Scanning is the process of detecting wireless local area networks (WLANs). A WLAN client device may scan, wait for a certain amount of time, and then scan again. The WLAN client device may conserve power by deactivating parts of its WLAN interface, for example a radio or a WLAN controller or both, in the time between successive scans. Typically the duration of intervals between successive scans in which no scan results are found, or in which no suitable scan results are found, is increased by the WLAN client device until it reaches an upper limit.

The more frequently a WLAN client device scans, the more power consumed, which may drain the battery of a battery-powered WLAN client device. On the other hand, the less frequently a WLAN client device scans, the more likely it is that some WLANs may be undetected by the WLAN client device or may be undetected for a longer period of time, thus adversely affecting the experience of a user of the WLAN client device.

### BRIEF DESCRIPTION OF THE DRAWINGS

Embodiments are illustrated by way of example and not limitation in the figures of the accompanying drawings, in which like reference numerals indicate corresponding, analogous or similar elements, and in which:

FIG. 1 is an illustration of exemplary thresholds for the rate of change of the location of a mobile device;

FIG. 2 is a flowchart of an exemplary method to be implemented when the rate of change of location of a mobile device exceeds a high threshold;

FIG. 3 is a block diagram of an exemplary mobile device;

FIG. 4 is a flowchart of an exemplary method to be implemented when the rate of change of location of a mobile device does not exceed a low threshold;

FIG. 5 is a flowchart of an exemplary method to determine from accelerometer interrupts whether a mobile device is stationary or moving;

FIG. 6 is a flowchart of an exemplary method for adjusting scanning for wireless local area networks according to what an accelerometer in a mobile device has determined about whether the mobile device is stationary or moving; and

FIG. 7 is a flowchart of an exemplary method to be implemented when the rate of change of location of a mobile device exceeds a low threshold and does not exceed a high threshold.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

A mobile device having a WLAN interface may perform different types of scans, depending on the circumstances. For example, if the mobile device is not currently connected to a WLAN, the mobile device may, from time to time, conduct what is known as “profile scanning”. Profile scanning involves detecting any WLANs in the vicinity and attempting to match any scan results to profiles of WLANs stored in the mobile device.

In another example, if the mobile device is currently connected to a WLAN, the mobile device may, from time to time, conduct “roaming scans”, in which the mobile device scans for access points (APs) supporting the same service set identifier (SSID) as the WLAN to which the mobile device is currently connected. The purpose of roaming scans is to identify neighboring APs that are possible handover candidates.

In yet another example, if the mobile device is currently connected to a WLAN, the mobile device may, from time to time, conduct profile scanning in the background. The background profile scanning may enable the display at the mobile device of updated results of which networks, if any, are within range of the mobile device and their received signal strengths. This may be helpful, for example, if more than one WLAN service provider is enabled for the mobile device. Some providers may have better coverage areas than others, but may charge more for connecting or for the amount of data transferred while connected. A user of the mobile device may use the provider with better coverage as a default and may use background profile scanning to identify access points belonging to less expensive WLAN service providers. The user may decide to disconnect from a WLAN of one WLAN service provider and connect to the WLAN of another WLAN service provider to save money or to regain better coverage after having switched to a less expensive WLAN service provider.

In a further example, the mobile device may be used in a “site survey” capacity to detect WLANs in the vicinity. Site surveys are typically performed by a person searching for unauthorized or rogue WLANs.

The inventors have realized that it may be appropriate to adjust certain scanning parameters for one or more of these different types of scans, depending on the rate of change of location of the mobile device. Examples of scanning parameters that may be adjusted include a back-off parameter that affects the time between successive scans, and a scan/don't scan parameter that according to its value prevents the mobile device from scanning or permits the mobile device to scan. The mobile device may maintain different back-off parameters for different types of scans. Determining which scanning parameters to adjust and how to adjust them may depend on whether the rate of change of location of the mobile device does not exceed a low threshold, exceeds a high threshold, or exceeds the low threshold and does not exceed the high threshold. Different thresholds may be applied by the mobile device for different types of scans.

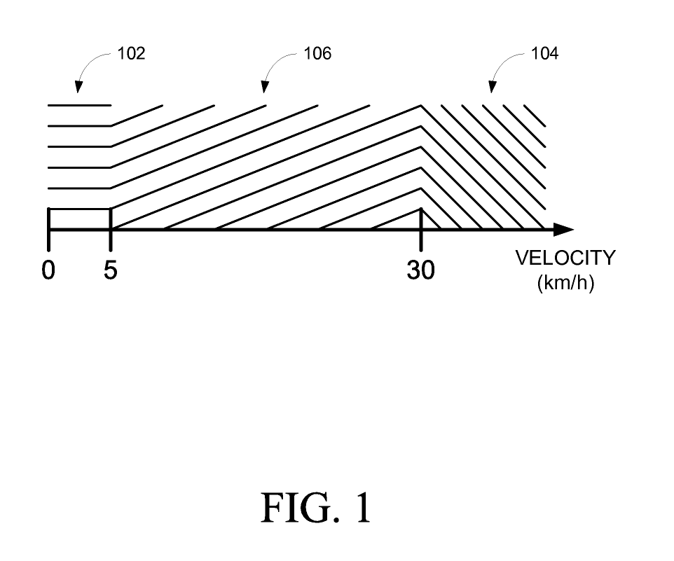

FIG. 1 is an illustration of exemplary thresholds for the rate of change of the location of a mobile device. A mobile device may be stationary or have a very slow rate of change of location, as indicated by a region 102 in which the rate of change of location of the mobile device does not exceed a low threshold, for example, 5 km/h. Other values for the low threshold are also contemplated, for example, 1 km/h. The mobile device may be resting in a fixed location, for example, placed on a desk, or may be carried by a person who is walking slowly.

A mobile device may have a very quick rate of change of location, as indicated by a region 104 in which the rate of change of location of the mobile device exceeds a high threshold, for example, 30 km/h. Other values for the high threshold are also contemplated, for example, 10 km/h, 20 km/h or 50 km/h. The mobile device may be located in a motorized vehicle, for example, a car or a bus.

A mobile device may have a rate of change of location that exceeds a low threshold and does not exceed a high threshold, as indicated by a region 106. For example, the mobile device may be carried by a person who is walking quickly, jogging, running or riding a bicycle.

WLANs are generally used for localized coverage. Current coverage areas of a single access point range between approximately 30 meters and 300 meters. If a mobile device is moving very quickly, so that its rate of change of location falls into region 104, then there is not sufficient time for the mobile device to detect and connect to an AP before the mobile device will be out of range of the AP.

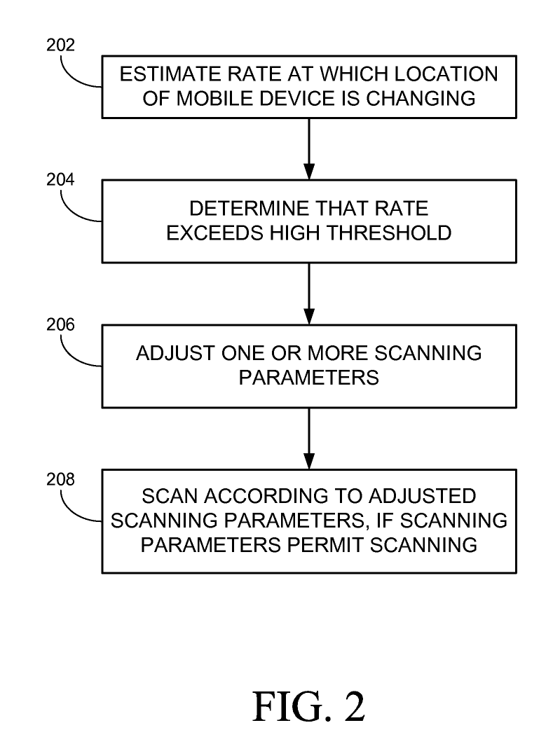

FIG. 2 is a flowchart of an exemplary method to be implemented when the rate of change of location of a mobile device exceeds a high threshold. At 202, the mobile device estimates the rate at which its location is changing. At 204, the mobile device determines that the rate estimated at 202 exceeds a high threshold. At 206, the mobile device adjusts one or more scanning parameters. For example, the mobile device may set a scan/don't scan parameter to a value that prevents the mobile device from scanning. This may enable the mobile device to deactivate parts of its WLAN interface, for example a radio or a WLAN controller or both, while the mobile device continues to move so quickly. In another example, the mobile device may set a back-off parameter that affects the time between successive scans to a value that results in longer times between successive scans than when the rate at which the location of the mobile device is changing does not exceed the high threshold or falls into region 106. The times between successive scans may be a fixed value, for example, 600 seconds, or may be a sequence of increasing times subject to an upper limit. If the mobile device is permitted to scan according to the scanning parameters, then at 208, the mobile device scans according to the adjusted scanning parameters.

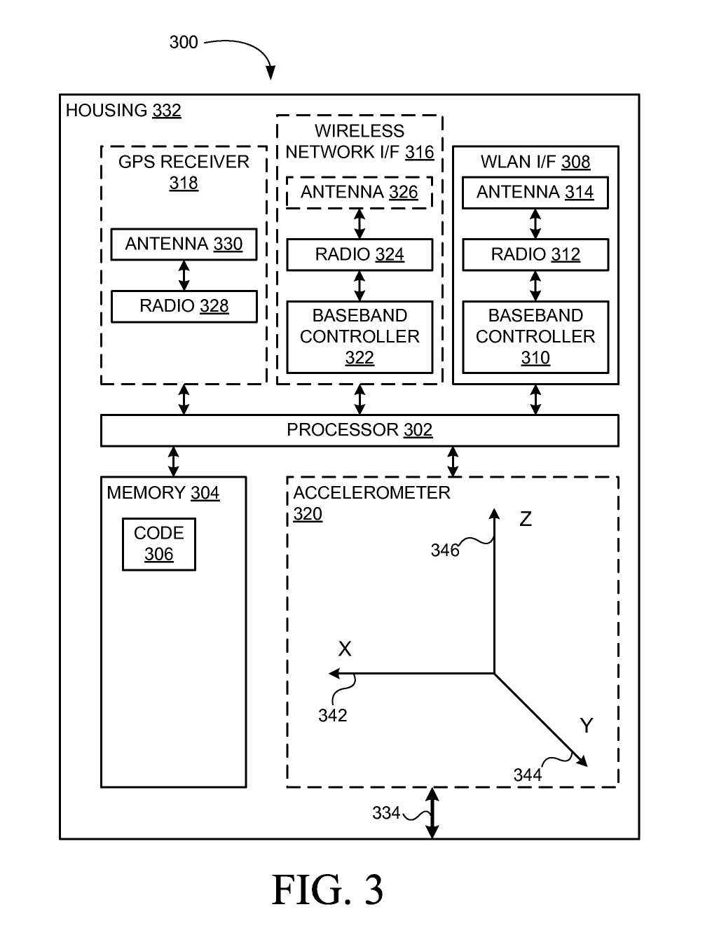

To better understand various options for estimating the rate at which the location of the mobile device is changing, reference is now made to FIG. 3, which is a block diagram of an exemplary mobile device 300. A non-exhaustive list of examples for mobile device 300 includes a wireless-enabled laptop, a wireless-enabled cellphone, a wireless-enabled personal digital assistant (PDA), a wireless-enabled smart phone, a wireless-enabled video camera, a wireless-enabled gaming console, a wireless Internet Protocol (IP) phone and any other suitable mobile device. Mobile device 300 may comprise components that, for clarity, are not shown in FIG. 3.

Mobile device 300 comprises a processor 302, and a memory 304 coupled to processor 302. Memory 304 is configured to store code 306 that, when executed by processor 302, may implement one or more of the methods described herein.

Mobile device 300 comprises a WLAN interface 308, compatible with one or more standards of the family of IEEE 802.11 wireless communication standards or with one or more ETSI HiperLAN standards. WLAN interface 308 is coupled to processor 302 and includes at least a baseband controller 310, a radio 312, and an antenna 314.

Mobile device 300 comprises a wireless network interface 316 coupled to processor 302 or a Global Positioning System (GPS) receiver 318 coupled to processor 302 or an accelerometer 320 coupled to processor 302 or any combination thereof.

Wireless network interface 316 is compatible with one or more wireless cellular communication standards or one or more wide area network communication standards. Wireless network interface 316 comprises at least a baseband controller 322 and a radio 324. Wireless network interface 316 may comprise an antenna 326 or may share antenna 314. Using information that is included in the signals received via wireless network interface 316, wireless network interface 316 or processor 302 or both may be able to estimate the geographic location of mobile device 300. In the case of a cellular network interface, a non-exhaustive list of methods for estimating the location of a cellular device from signals received via cellular network interface 316 includes RSS (received signal strength) positioning, E-OTD (Enhanced Observed Time Difference), TOA (time of arrival) positioning, U-TDOA (Uplink Time Difference of Arrival), WLS (Wireless Location Signature), A-GPS (assisted GPS), ALFT, ELFT, Radio Fingerprinting, AOA (Angle of Arrival) positioning, MNLS, CGI (Cell Global Identity), CGI+Timing Advance, Enhanced Cell ID, and any other appropriate method. With U-TDOA, for example, latitude and longitude can be typically calculated with an accuracy of about 50 meters. Similar techniques may be applied in the case where wireless network interface 316 is compatible with one or more wide area network communication standards, such as IEEE 802.16, WiMAX and Broadband Wireless Access (BWA).

GPS receiver 318 may be coupled to mobile device 300 or integrated into mobile device 300. GPS receiver 318 comprises at least a radio 328 and an antenna 330 and may be able to receive signals that originate from GPS satellites. Using information that is included in signals received via GPS receiver 318, GPS receiver 318 or processor 302 or both may be able to estimate the geographic location of mobile device 300. The accuracy of location estimation using GPS is subject to errors due to Ionospheric effects, Ephemeris errors, Satellite clock errors, Multipath distortion, Tropospheric effects, Numerical errors and other errors, and may be in the range of approximately 2 meters to 20 meters.

The geographical location of mobile device 300, whether determined using information from wireless network interface 316 or using information received by GPS receiver 318, may be used to estimate the rate at which the location of mobile device 300 is changing.

Accelerometer 320 is mechanically coupled to a housing 332 of mobile device 300, as indicated by an arrow 334, and is able to detect acceleration of housing 332, the velocity of housing 332, or both. Accelerometer 320 may therefore be considered embedded in mobile device 300.

Accelerometer 320 is able to detect the acceleration of housing 332 along an axis 342, along an axis 344 that is perpendicular to axis 342, and along an axis 346 that is perpendicular to axis 342 and is perpendicular to axis 344. Axes 342, 344 and 346 may be mechanically fixed relative to housing 332 and their orientation relative to housing 332 is an arbitrary design option.

In alternative implementations, not shown in FIG. 3, accelerometer 320 may detect accelerations along axes that are not perpendicular to one another, or may be replaced by two or more single-axis accelerometers. In other alternative implementations, not shown in FIG. 3, accelerometer 320 may be replaced by a velocity sensing device or a combination of an accelerometer and a velocity sensing device.

As is known in the art, accelerometer 320 or processor 302 or both may be able to derive velocity and displacement (position change) information from acceleration information produced by accelerometer 320. As is known in the art, accelerometer 320 or processor 302 or both may be able to derive acceleration and position change information from velocity information produced by accelerometer 320. Accelerometer 320 may be able to detect and measure changes in the orientation and location of housing 332.

Unlike the GPS system, accelerometer 320 may not be able to estimate an absolute location of device 300. However, accelerometer 320 may be able to detect changes in the position of device 300 with an accuracy of centimeters and even millimeters, which is much higher than the accuracy provided by the GPS system.

Accelerometer 320 may be used to determine whether mobile device 300 is stationary or moving. For example, when no significant movement in the horizontal plane is detected for a period of time, accelerometer 320 or processor 302 or both may determine that mobile device 300 is stationary. The movement may be determined as the square root of the sum of squares of the x- and y-acceleration values generated along axes 342 and 344, respectively. For example, the accelerometer may be sampled 50 times per second and within a period of 1 to 2 seconds, the acceleration values generated may be checked. Acceleration values that are primarily non-zero indicate that mobile device 300 is moving.

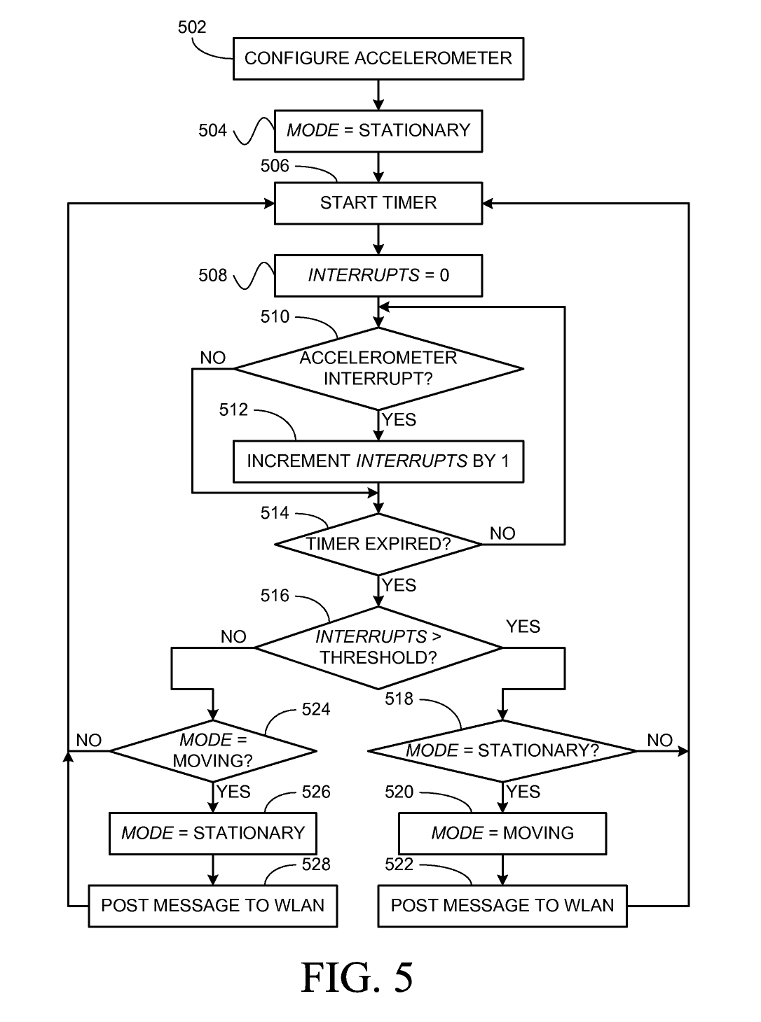

Some accelerometers generate a threshold-indication signal, for example, an interrupt, and can be programmed to generate the signal if the X, Y or Z components exceed preprogrammed thresholds. The values of the preprogrammed thresholds may affect the sensitivity of accelerometer 320. For example, consider the situation where a person carrying mobile device 300 begins walking suddenly from a stationary position. There will be an initial acceleration that may be detected by accelerometer 320, but if the person continues to walk in a single direction at a relatively fixed speed, accelerometer 320 may not detect any further acceleration if the thresholds are set too high. Accelerometer 320 will therefore be unable to determine a rate of change of location of mobile device 300 merely based on the threshold-indication signals. If, however, the thresholds are set sufficiently low that even walking in a single direction at a relatively fixed speed triggers the threshold-indication signals, then merely shaking mobile device 300 without actually changing its location will also trigger the threshold-indication signals. That may indeed be a desirable side effect, in that the user of mobile device 300 may intentionally shake mobile device 300 to cause it to start scanning for WLANs more frequently than when mobile device 300 was deemed to be stationary. If no such threshold-indication signals are received for longer than a period of time, accelerometer 320 or processor 302 or both may determine that mobile device 300 is stationary. This is explained in more detail below with respect to FIG. 5.

If the mobile device is stationary and currently connected to a WLAN, disabling background profile scans or performing them infrequently may enable the mobile device to conserve power. Likewise, if the mobile device is stationary and currently connected to a WLAN, disabling roaming scans or performing them infrequently may enable the mobile device to conserve power.

If the mobile device is stationary and not currently connected to a WLAN, disabling profile scans or performing them infrequently may enable the mobile device to conserve power. If the mobile device is not currently connected to any WLAN, the reason for this may be that there are no WLANs in the vicinity or the mobile device lacks the security credentials to associate with or connect to any of the WLANs within range of the mobile device. Since those conditions are unlikely to change, frequent profile scans may be a poor use of battery power.

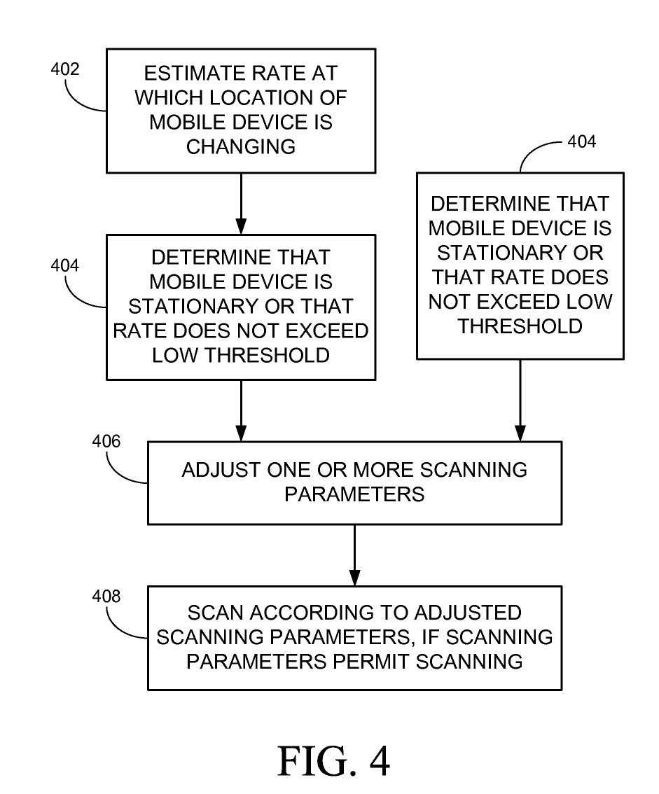

FIG. 4 is a flowchart of an exemplary method to be implemented when the rate of change of location of a mobile device does not exceed a low threshold. At 402, the mobile device estimates the rate at which its location is changing. At 404, the mobile device determines that the rate estimated at 402 exceeds a high threshold. It may be possible for the mobile device to determine that the mobile device is stationary or that its rate does not exceed the low threshold without first estimating the rate at which the location of the mobile device is changing. This is indicated in FIG. 4 by another box referenced 404.

At 406, the mobile device adjusts one or more scanning parameters. For example, the mobile device may set a scan/don't scan parameter to a value that prevents the mobile device from scanning. This may enable the mobile device to deactivate parts of its WLAN interface, for example a radio or a WLAN controller or both, while the mobile device is stationary or moves very slowly. In another example, the mobile device may set a back-off parameter that affects the time between successive scans to a value that results in longer times between successive scans than when the rate at which the location of the mobile device is changing exceeds the low threshold. The times between successive scans may be a fixed value, for example, 600 seconds, or may be a sequence of increasing times subject to an upper limit. The fixed value or the sequence of increasing times and upper limit need not be the same as in the case where the rate at which the location of the mobile device is changing exceeds a high threshold. If the mobile device is permitted to scan according to the scanning parameters, then at 408, the mobile device scans according to the adjusted scanning parameters.

The various exemplary techniques by which the mobile device may be able to estimate the rate at which its location is changing, or by which the mobile device may be able to determine that the rate at which its location is changing does not exceed a low threshold, or by which the mobile device may be able to determine that it is stationary, all described hereinabove with respect to FIG. 3, are applicable to the exemplary method described with respect to FIG. 4.

As mentioned above, an accelerometer equipped with threshold-indicator signals may be used to determine whether the mobile device is stationary or moving, without first estimating the rate at which the location of the mobile device is changing.

FIG. 5 is a flowchart of an exemplary method to determine from accelerometer interrupts whether a mobile device is stationary or moving.

At 502, the accelerometer is configured. At 504, a mode flag is set to the value “stationary”. At 506, a timer is started, and at 508, an interrupts variable is initialized to zero. If an accelerometer interrupt occurs, as checked at 510, this is an indication that an acceleration value along one of the axes has exceeded a threshold, and at 512, the interrupts variable is incremented by one. Checking for accelerometer interrupts and incrementing the interrupts variable is repeated until the timer has expired, as checked at 514. At that point, it is checked at 516 whether the value of the interrupts variable exceeds a threshold.

If the value of the interrupts variable as checked at 516 exceeds the threshold, this is an indication that the mobile device is moving and is not stationary. At 518, it is checked whether the value of the mode flag is “stationary”. If not, then this is consistent with having the value of the interrupts variable exceed the threshold, and the method therefore resumes from 506. If the value of the mode flag, when checked at 518, is “stationary”, this means that the most recent determination that the mobile device is stationary is no longer accurate, and at 520 the mode flag is set to the value “moving”. At 522 a message to this effect is posted to the WLAN interface of the mobile device and the method resumes from 506.

If the value of the interrupts variable as checked at 516 does not exceed the threshold, this is an indication that the mobile device is stationary and is not moving. At 524, it is checked whether the value of the mode flag is “moving”. If not, then this is consistent with having the value of the interrupts value not exceed the threshold, and the method therefore resumes from 506. If the value of the mode flag, when checked at 524, is “moving”, this means that the most recent determination that the mobile device is moving is no longer accurate, and at 526 the mode flag is set to the value “stationary”. At 528 a message to this effect is posted to the WLAN interface of the mobile device and the method resumes from 506.

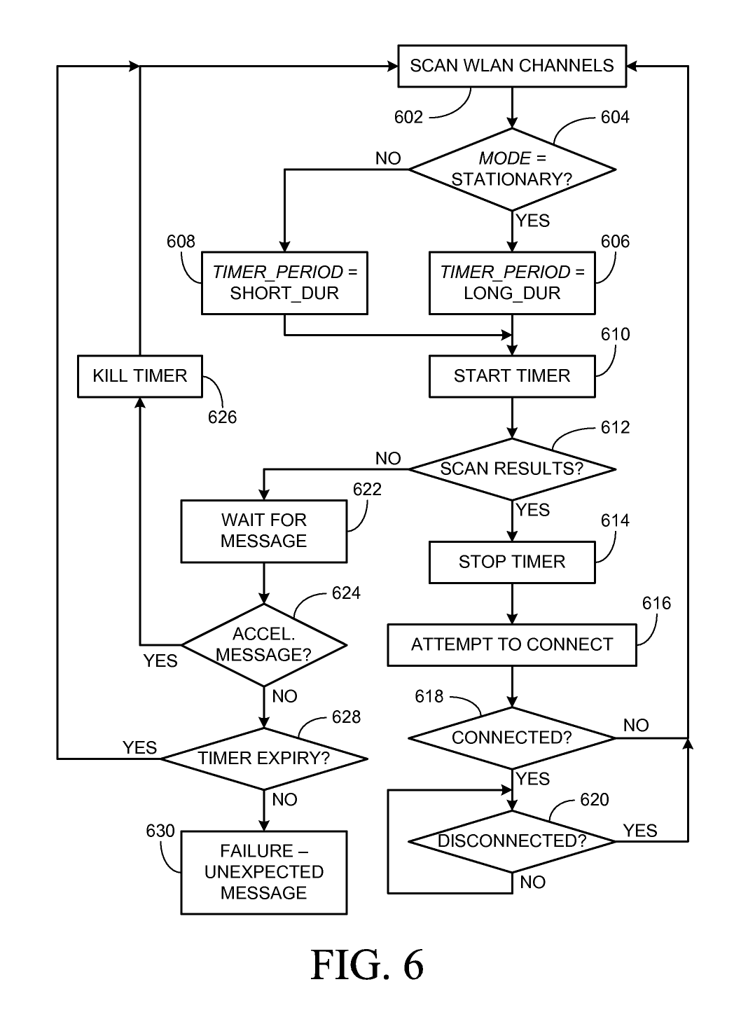

FIG. 6 is a flowchart of an exemplary method for adjusting scanning for wireless local area networks according to what an accelerometer in a mobile device has determined about whether the mobile device is stationary or moving.

At 602, the mobile device scans for WLANs. At 604, the mobile device checks whether the value of the mode flag is “stationary”. If so, then at 606 the mobile device sets a timer_period variable to a relatively long duration, and if not, then at 608 the mobile device sets the timer_period variable to a relatively short duration. The value of the timer_period variable is representative of a fixed back-off between successive scans.

At 610, a timer is started, and at 612 the mobile device checks whether any scan results have been obtained. If so, then the timer is stopped at 614, and the mobile device attempts at 616 to connect to an AP corresponding to one of the scan results. At 618, the mobile device checks whether the attempt to connect has succeeded. If not, then the method resumes from 602 to scan again for WLANs. If the mobile device has successfully connected to the AP, then monitoring for disconnection occurs at 620 and in the event of a disconnection, the method resumes from 602 to scan again for WLANs. If at 612 no scan results have been obtained, then the mobile device waits at 622 for a message. If an accelerometer message has been received, as checked at 624, this is an indication that the status of the mobile device as stationary or moving has changed. The timer is killed at 626 and the method resumes from 602 to scan again for WLANs. If a timer expiry message has been received, as checked at 628, then the method resumes from 602 to scan again for WLANs. If the message received is neither an accelerometer message nor a timer expiry message, this is an error, as indicated at 630.

An alternative to the method described with respect to FIG. 6 is to change the duration between successive scans based on whether the mobile device is stationary or moving, subject to the following constraints: (a) connecting to a WLAN resets the back-off mode; (b) if the mobile device loses WLAN coverage then standard incremental back-off is used regardless of whether the mobile device is stationary or moving; (c) when the mobile device reaches the upper limit of the incremental back-off values, the mobile device may switch to an even longer fixed back-off if the mobile device becomes stationary; (d) if the mobile device is moved while configured for the longer fixed back-off, it then switches to the upper limit of the incremental back-off values.

Consider the following usage scenario. An information technology (IT) networking employee is wandering between corporate buildings on a corporate campus to site survey the air space looking for unauthorized or rogue APs. If the employee is using a mobile device and is scanning for networks very frequently even when stopped in front of a building for a few minutes, then the battery of the mobile device is unnecessarily being drained. On the other hand, if the employee sets the site survey application to scan infrequently, there is a risk that an unauthorized or rogue AP may remain undetected due to the delay between successive scans. If scanning is performed less frequently when the employee is stationary or walking more slowly than when the employee is walking more quickly, battery power may be conserved without increasing the risk of not detecting unauthorized or rogue APs.

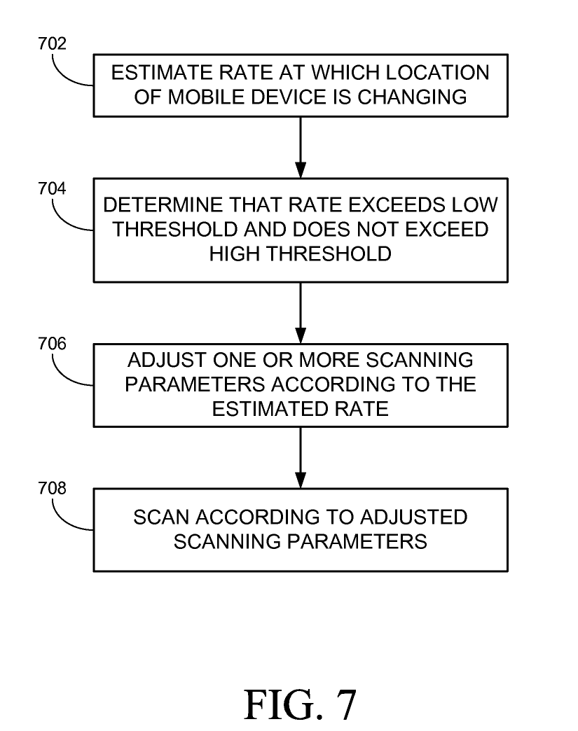

FIG. 7 is a flowchart of an exemplary method to be implemented when the rate of change of location of a mobile device exceeds a low threshold and does not exceed a high threshold.

At 702, the mobile device estimates the rate at which its location is changing. At 704, the mobile device determines that the rate estimated at 702 exceeds a low threshold and does not exceed a high threshold. At 706, the mobile device adjusts one or more scanning parameters. For example, the mobile device may set a back-off parameter that affects the time between successive scans to a value that results in shorter times between successive scans for higher estimated rates. At 708, the mobile device scans according to the adjusted scanning parameters.

In one embodiment, for any given estimated rate of change of location of the mobile device, where the rate exceeds a low threshold and does not exceed a high threshold, the time between successive scans may be a fixed value. The fixed value may be a monotonically decreasing function of the estimated rate. Alternatively, the fixed value may be selected from a set of fixed values, where longer times are selected for lower estimated rates and shorter times are elected for higher estimated rates.

In another embodiment, for any given estimated rate of change of location of the mobile device, where the rate exceeds a low threshold and does not exceed a high threshold, the times between successive scans may be a sequence of increasing times subject to an upper limit. A “base” sequence of increasing times, for example, 1 second, 3 seconds, 7 seconds, 15 seconds, 30 seconds, 60 seconds, may be multiplied by a factor that is related to the estimated rate to yield the actual sequence of times between successive scans. The factor may be higher (yielding longer times between successive scans) for lower estimated rates, and lower (yielding shorter times between successive scans) for higher estimated rates. The factor may be selected from a set of fixed values.

The various exemplary techniques by which the mobile device may be able to estimate the rate at which its location is changing, or by which the mobile device may be able to determine that the rate at which its location is changing exceeds a low threshold and does not exceed a high threshold, all described hereinabove with respect to FIG. 3, are applicable to the exemplary method described with respect to FIG. 7.

Although the subject matter has been described in language specific to structural features or methodological acts or both, it is to be understood that the subject matter defined in the appended claims is not necessarily limited to the specific features or acts described above. Rather, the specific features and acts described above are disclosed as example forms of implementing the claims.

What is claimed is:

1. A method in a mobile device having a wireless local area network interface, the method comprising:
determining that a rate at which the location of the mobile device is changing exceeds a threshold; and
consequently adjusting one or more scanning parameters that affect how the wireless local area network interface scans for wireless local area networks.

2. The method of claim 1, wherein adjusting the one or more scanning parameters comprises:
setting a parameter that prevents the mobile device from scanning.

3. The method of claim 1, wherein adjusting the one or more scanning parameters comprises:
setting a back-off parameter that affects the time between successive scans to a value that results in longer times between successive scans than when the rate at which the location of the mobile device is changing does not exceed the threshold.

4. The method of claim 1, wherein determining that the rate exceeds the threshold comprises:
estimating the rate from information received by a global positioning system ‘GPS’ receiver coupled to or integrated into the mobile device.

5. The method of claim 1, wherein determining that the rate exceeds the threshold comprises:
estimating the rate from information received by the mobile device from an accelerometer embedded in the mobile device.

6. The method of claim 1, wherein determining that the rate exceeds the threshold comprises:
estimating the rate from cellular network signals received by the mobile device from a cellular network interface of the mobile device.

7. The method of claim 1, wherein determining that the rate exceeds the threshold comprises:
estimating the rate from wide area network signals received by the mobile device from a wide area network interface of the mobile device.

8. A method in a mobile device having a wireless local area network interface, the method comprising:
estimating a rate at which the location of the mobile device is changing;
determining that the estimated rate exceeds a low threshold and does not exceed a high threshold; and
consequently adjusting, according to the estimated rate, one or more scanning parameters that affect how the wireless local area network interface scans for wireless local area networks.

9. The method of claim 8, wherein adjusting the one or more scanning parameters comprises:
setting a back-off parameter that affects the time between successive scans to a value that results in shorter times between successive scans for higher estimated rates.

10. The method of claim 8, wherein estimating the rate comprises:
estimating the rate from information received by a global positioning system ‘GPS’ receiver coupled to or integrated into the mobile device.

11. The method of claim 8, wherein estimating the rate comprises:
estimating the rate from information received by the mobile device from an accelerometer embedded in the mobile device.

12. The method of claim 8, wherein estimating the rate comprises:
estimating the rate from cellular network signals received by the mobile device from a cellular network interface of the mobile device.

13. The method of claim 8, wherein estimating the rate comprises:
estimating the rate from wide area network signals received by the mobile device from a wide area network interface of the mobile device.

14. A method in a mobile device having a wireless local area network interface, the method comprising:
determining that a rate at which the location of the mobile device is changing does not exceed a threshold; and
consequently setting a back-off parameter that affects the time between successive scans by the wireless local area network interface to a value that results in longer times between successive scans than when the rate at which the location of the mobile device is changing exceeds the threshold.

15. The method of claim 14, wherein determining that the rate does not exceed the threshold comprises determining that the mobile device is stationary, the method further comprising:
setting a parameter that prevents the mobile device from scanning.

16. The method of claim 14, wherein determining that the rate does not exceed the threshold comprises:
estimating the rate from information received by a global positioning system ‘GPS’ receiver coupled to or integrated into the mobile device.

17. The method of claim 14, wherein determining that the rate does not exceed the threshold comprises:
estimating the rate from acceleration values received by the mobile device from an accelerometer embedded in the mobile device.

18. The method of claim 14, wherein determining that the rate does not exceed the threshold comprises:
determining that the mobile device is stationary from a threshold-indication signal generated by an accelerometer embedded in the mobile device.

19. The method of claim 14, wherein determining that the rate does not exceed the threshold comprises:
estimating the rate from cellular network signals received by the mobile device from a cellular network interface of the mobile device.

20. The method of claim 14, wherein determining that the rate does not exceed the threshold comprises:
estimating the rate from wide area network signals received by the mobile device from a wide area network interface of the mobile device.
